(19) United States
(12) Patent Application Publication
(10) Pub. No.: US 2025/0255330 A1
(43) Pub. Date: Aug. 14, 2025

(54) COMPOSITION FOR PREPARING BOILING HOT WATER FOR BROTH, INSTANT BROTH NOODLES FOOD WITH SIMMERED BONE TASTE AND METHOD FOR COOKING INSTANT BROTH NOODLES WITH SIMMERED BONE TASTE

(71) Applicant: ICHIRAN INC., Fukuoka (JP)

(72) Inventor: Takashi ARIYOSHI, Fukuoka (JP)

(21) Appl. No.: 18/857,525

(22) PCT Filed: Apr. 27, 2023
(86) PCT No.: PCT/JP2023/016662

§ 371 Date: Oct. 17, 2024

(30) Foreign Application Priority Data
Apr. 28, 2022 (JP) 2022-075202

(51) Int. Cl. A23L 23/00; A23L 7/113

(52) U.S. Cl. CPC A23L 23/00; A23L 7/113

(57) ABSTRACT

A composition is used for preparing boiling hot water for broth. The boiling hot water for broth is used to boil noodles, and after the noodles are boiled, and a seasoning is added to make broth in an instant broth noodles with a simmered bone taste. The prepared boiling hot water for broth contains 0.390 to 5.000 w/w % of oil, 0.001 to 0.400 w/w % of an emulsifier, and 0.001 to 0.800 w/w % of a thickening polysaccharide. These amounts are derived from the composition for preparing the boiling hot water for broth.

### TECHNICAL FIELD

The present invention relates to a composition for preparing boiling hot water for broth, an instant broth noodles food with a simmered bone taste, and a method for cooking instant broth noodles with a simmered bone taste.

### BACKGROUND ART

Conventionally, for example, a noodle dish (hereinafter, it is also referred to as broth noodles) in which noodles are put into a broth like ramen is widely eaten regardless of age and sex.

Among them, pork bone broth ramen is one of the ramen noodles boasting strong popularity, and its taste is characterized by rich pork bone broth.

For example, in a general street ramen shop, a pork bone broth used for pork bone broth ramen is prepared by putting pork bone or other ingredients in a cylindrical pot in a kitchen of the shop and obtaining a cloudy extract while simmering over high heat for a long time (see, for example, Patent Literature 1). Incidentally, a method of obtaining the broth as described above from the “broth bone” such as a pork bone, a cow bone, or a chicken broth bone is also referred to as a simmering method.

### CITATION LIST

### Patent Literature

Patent Literature 1: JP 9-248161 A

### SUMMARY OF INVENTION

### Technical Problem

Meanwhile, in retail stores such as supermarkets, convenience stores, and gift shops, pork bone broth ramen is widely sold as instant food. As the instant food product, for example, instant food products with various tastes are provided in various forms such as so-called pot noodles and bagged noodles.

However, the actual situation is that the pork bone broth ramen provided as an instant food is not as good as the taste of the pork bone broth ramen provided in shops in town.

In this regard, as a result of intensive research by the present inventors, it was considered that the difference in eating quality between the two is greatly affected by the state of the broth at the time of eating.

The present invention has been made in view of the above circumstances, and provides a composition for preparing boiling hot water for broth, which is used in a cooking method of an instant broth noodles food with a simmered bone taste such as a broth (simmered bone broth) obtained by simmering broth bone such as pork bone broth, chicken bone broth, beef bone broth, or the like, or a broth expressing a taste similar to the broth, the cooking method being capable of achieving a taste similar to the broth noodles prepared with the simmered bone broth obtained by the simmering method.

In addition, the present application also provides an instant broth noodles food with a simmered bone taste including the composition for preparing boiling hot water for broth and a method for cooking the instant broth noodles food with a simmered bone taste.

### Solution to Problem

In order to solve the above conventional problems, the composition for preparing boiling hot water for broth according to the present invention is (1) a composition for preparing boiling hot water for broth, in which the boiling hot water for broth is the boiling hot water used to boil the noodles, and after the noodles are boiled, and a seasoning is added to make the broth for broth in an instant broth noodles with a simmered bone taste, in which in the prepared boiling hot water for broth 0.390 to 5.000 w/w % of oil, 0.001 to 0.400 w/w % of an emulsifier, and 0.001 to 0.800 w/w % of a thickening polysaccharide contain the oil, the emulsifier, and the polysaccharide thickener in amounts derived from the composition for preparing the boiling hot water for broth.

The composition for preparing boiling hot water for broth according to the present invention is also characterized in that (2) the emulsifier corresponding to 0.05 to 10 w/w % of the oil is blended.

In addition, the instant broth noodles food with a simmered bone taste according to the present invention includes (3) the composition for preparing boiling hot water for broth according to the above (1) or (2), noodles, and a seasoning agent for adding to the used boiling hot water for broth after boiling of the noodles to prepare a broth with a simmered bone taste.

In addition, in the method for cooking the instant broth noodles food with a simmered bone taste according to the present invention, (4) boiling hot water for broth is prepared by adding the composition for preparing boiling hot water for broth according to the above (1) or (2) to water or hot water, noodles are put into the boiling hot water to boil the noodles in a state accompanied by boiling, and a seasoning agent for preparing the broth with a simmered bone taste is added to the boiling hot water for broth to obtain instant broth noodles with a simmered bone taste.

### Advantageous Effects of Invention

According to the composition for preparing boiling hot water for broth of the present invention, there is provided the composition for preparing boiling hot water for broth according to the present invention is a composition for preparing boiling hot water for broth, in which the boiling hot water for broth is the boiling hot water used to boil the noodles, and after the noodles are boiled, and a seasoning is added to make the broth for broth in an instant broth noodles with a simmered bone taste, in which in the prepared boiling hot water for broth 0.390 to 5.000 w/w % of oil, 0.001 to 0.400 w/w % of an emulsifier, and 0.001 to 0.800 w/w % of a thickening polysaccharide contain the oil, the emulsifier, and the polysaccharide thickener in amounts derived from the composition for preparing the boiling hot water for broth, and therefore when cooking an instant broth noodles food with a simmered bone taste, it is possible to provide a composition for preparing boiling hot water for broth to be used in a cooking method being capable of achieving a taste similar to the broth noodles prepared with the simmered bone broth obtained by the simmering method.

In addition, if the emulsifier corresponding to 0.05 to 10 w/w % of the oil is blended, it is possible to provide a composition for preparing boiling hot water for broth to be used in a cooking method capable of more reliably achieving a taste similar to the broth noodles prepared with the simmered bone broth obtained by the simmering method.

Further, the instant broth noodles food with a simmered bone taste according to the present invention includes the composition for preparing boiling hot water for broth, the noodles, and the seasoning agent for adding to boiling hot water for broth after boiling of the noodles to prepare a broth with a simmered bone taste, so that it is possible to provide the instant broth noodles food with a simmered bone taste with a taste similar to the broth noodles prepared with the simmered bone broth obtained by the simmering method.

In addition, according to the method for cooking the instant broth noodles food with a simmered bone taste according to the present invention, boiling hot water for broth is prepared by adding the composition for preparing boiling hot water for broth to water or hot water, noodles are put into the boiling hot water to boil the noodles in a state accompanied by boiling, and a seasoning agent for preparing the broth with a simmered bone taste is added to the boiling hot water for broth to obtain instant broth noodles with a simmered bone taste. Therefore, it is possible to provide an instant broth noodles food with a simmered bone taste being capable of achieving a taste similar to the broth noodles prepared with the simmered bone broth obtained by the simmering method.

### DESCRIPTION OF EMBODIMENTS

The present invention relates to a composition for preparing boiling hot water for broth. Specifically, the present invention provides a composition for preparing boiling hot water for broth, in which the boiling hot water for broth is the boiling hot water used to boil the noodles, and after the noodles are boiled, and a seasoning is added to make the broth for broth in an instant broth noodles with a simmered bone taste.

Herein, the broth bone means a bone of an animal after meat is taken (including some meat or muscle remaining), and representatively includes, but is not limited to, a pork bone, a chicken broth bone, a cow bone, a fish bone, and the like.

In addition, the simmered bone broth is a broth prepared by simmering the above-described broth bone, and examples thereof include a pork bone broth, a chicken bone broth, a beef bone broth, and a fish bone broth.

In addition, the broth with a simmered bone taste is a concept including, in addition to the simmered bone broth, a broth in which a flavor of a simmered bone is reproduced by some method without simmering a broth bone, for example, a broth with a pork bone flavor, a broth with a chicken broth bone flavor, a broth with a beef bone flavor, or a broth with a fish bone flavor.

In addition, the instant broth noodles are instant broth noodles that can be eaten (food state) by pouring boiling water, boiling with a pot, or the like. The instant broth noodles food is in a state before cooking of instant broth noodles, and for example, a seasoning agent (broth base) is packed in a product package so that the broth can be cooked at the same time, and is a concept including so-called instant noodles.

The composition for preparing boiling hot water for broth according to the present embodiment is a composition for achieving eating quality similar to the broth noodles prepared with the simmered bone broth obtained by the simmering method, by previously adding the same composition to the boiling hot water when preparing instant broth noodles with simmered bone taste accompanied by boiling of the noodles, on the premise that boiling hot water used for boiling the noodles is used as the broth with a simmered bone taste in the broth noodles. Note that the boiling hot water for broth is boiling hot water used as a broth with a simmered bone taste of broth noodles.

The composition for preparing boiling hot water for broth contains oil, an emulsifier, and a thickening polysaccharide. When the oil constituent ratio in the composition for preparing boiling hot water for broth preparation is 1, the emulsifier is preferably about 0.0002 to 1.1, and more preferably in an amount corresponding to 0.05 to 10 w/w % of the oil. When the oil constituent ratio in the composition for preparing boiling hot water for broth preparation is 1, the thickening polysaccharide is preferably about 0.0002 to 2.1.

In addition, the amount of oil, emulsifier, or thickening polysaccharide constituting the composition for preparing boiling hot water for broth preparation can be set to an amount corresponding to the preparation amount of boiling hot water for broth or target eating quality. For example, if the amount of noodles per person constituting the instant broth noodles food with a simmered bone taste is large, it is common to increase the amount of boiling hot water, and accordingly, the amount of the composition for preparing boiling hot water for broth increases. In addition, for example, when reproducibility is not so much required as compared with the simmered bone broth obtained by the simmering method, it is also possible to design to reduce the addition ratio of the composition for preparing boiling hot water for broth to boiling hot water for broth in consideration of the eating quality balance derived from other materials.

When the amounts of the oil, emulsifier, and thickening polysaccharide that constitute the composition for preparing boiling hot water for broth are purposely specified, for example, the composition for preparing boiling hot water for broth can be constituted so that 0.390 to 5.000 w/w % of the oil, 0.001 to 0.400 w/w % of the emulsifier, and 0.001 to 0.800 w/w % of the thickening polysaccharide are contained in the prepared boiling hot water for broth before being subjected to noodles boiling in an amount derived from the composition for preparing boiling hot water for broth, the emulsifier, and the thickening polysaccharide.

The oil constituting the composition for preparing boiling hot water for broth is not particularly limited as long as it is an edible fat and oil that is approximately liquid at the time of boiling noodles or eating, and for example, animal fats and oils such as lard, beef tallow, and chicken fat, or vegetable fats and oils such as a rapeseed oil and a soybean oil can be suitably used, and a mixture of two or more of them can also be used.

The emulsifier is not particularly limited as long as it has an HLB of about 3 to 16, preferably about 3 to 13, more preferably about 7 to 9, on the premise that it can be used for food. For example, a glycerin fatty acid ester, a sucrose fatty acid ester, lecithin, or the like can be used, and a mixed emulsifier obtained by mixing two or more of them can also be used. When a mixed emulsifier is used as the emulsifier, the sum of products of the HLB value of each emulsifier (it is also referred to as a constituent emulsifier) constituting the mixed emulsifier and the blending weight ratio (%) thereof, that is, the HLB value as the mixed emulsifier is desirably about 7 to 9. The constituent emulsifier may have an HLB of about 3 to 16, and may be a mixed emulsifier itself.

In addition, the thickening polysaccharide is not particularly limited as long as it can be used for food, and for example, pectin, xanthan gum, guar gum, and the like can be used, and a plurality of these can be mixed and used. The ratio of the thickening polysaccharides to be used is not particularly limited, but in order to faithfully reproduce the broth noodles prepared with the simmered bone broth obtained by the simmering method that looks just like a ramen served in a store as much as possible, it is one idea to use xanthan gum and guar gum at a final concentration in the boiled hot water at a ratio of xanthan gum:guar gum =1:1 to 3.

According to the composition for preparing boiling hot water for broth of the present embodiment, by having such a constitution, it is possible to provide the composition for preparing boiling hot water for broth to be used in a cooking method being capable of achieving a taste similar to the broth noodles prepared with the simmered bone broth obtained by the simmering method when cooking the instant broth noodles food with a simmered bone taste.

The present application also provides an instant broth noodles food with a simmered bone taste including the composition for preparing boiling hot water for broth according to the present embodiment. That is, the instant broth noodles food with a simmered bone taste according to the present embodiment includes the above-described composition for preparing boiling hot water for broth, noodles, and a seasoning agent added to the boiling hot water for broth after boiling of the noodles to prepare a broth with a simmered bone taste.

In addition, the instant broth noodles food with a simmered bone taste according to the present embodiment is prepared by boiling noodles during cooking. In light of instant broth noodles foods provided in supermarkets, convenience stores, and the like in recent years, the instant broth noodles food are similar to image to so-called instant broth noodles foods of bagged noodles type or rod-shaped noodles type in which noodles are boiled in a pot, but instant broth noodles foods of pot noodles type are also not impossible to be cooked by boiling noodles in a pot, and thus are not excluded.

The noodles constituting the instant broth noodles food with a simmered bone taste may be any noodles that can also be eaten by boiling the noodles, such as noodles that can be made ready to eat by cooking without boiling, for example, by being made ready to eat with boiling water or by being made ready to eat over a flame without boiling. It is desirable that the noodles do not elongate by boiling the noodles for a predetermined time accompanied by boiling.

The seasoning agent is an agent to be added to the boiling hot water for broth after the composition for preparing boiling hot water for broth is added and used for boiling noodles to prepare a broth with a simmered bone taste. The seasoning agent may be in the form of powder, liquid, or paste. In addition, the taste exhibited by the seasoning agent may be a pork bone broth flavor in which the taste of the pork bone broth is reproduced by various seasoning agents or the like, in addition to the pork bone broth, the chicken bone broth taste, and the beef bone broth taste as described above.

In particular, even in a case where the meat of livestock is unable to be eaten due to a religious reasons, the composition for preparing boiling hot water for broth according to the present embodiment can reproduce the same texture as that of the simmered bone broth obtained by the simmering method, and by adopting a seasoning agent with a desired flavor, it is possible to achieve an instant broth noodles with simmered bone taste similar to genuine simmered bone broth noodled.

In addition, the present application also provides a method for cooking the instant broth noodles food with a simmered bone taste according to the present embodiment. That is, the cooking method according to the present embodiment is to prepare boiling hot water for broth by adding the composition for preparing boiling hot water for broth to water or hot water to prepare a boiling hot water for broth, putting noodles into the boiling hot water for broth and boiling the noodles in a state accompanied by boiling, and adding a seasoning agent for preparing a broth with a simmered bone taste to the used boiling hot water for broth to obtain an instant broth noodles with a simmered bone taste.

The boiling time is a time required for the components derived from the composition for preparing boiling hot water for broth to disperse in boiling water and to give a feeling of touch on the tongue and a feeling of richness similar to that of simmered bone broth, and is at least 30 seconds or more, preferably 1 minute or more. On the other hand, the upper limit of the boiling time is not particularly limited as in the case of obtaining broth by the simmering method, but needs to be adjusted according to the appropriate degree of boiling (degree of elongation) of the noodles, and for example, about 1 to 10 minutes, more preferably about 2 to 5 minutes is appropriate due to the nature of instant noodles to be eaten quickly. In the present specification, boiling does not necessarily need to be maintained at about 100° C., and such cooking is generally difficult at home, store, or the like from the viewpoint of boiling over. It should be understood that boiling in the present specification includes not only a case where the entire boiling hot water is boiling, but also a state where the entire boiling hot water is in a state of boiling water suitable for boiling noodles, air bubbles ascend from a part of the boiling hot water, for example, a part of a pot bottom in contact with direct flame, and the boiling hot water circulates vertically, and a state where the boiling hot water is approximately 95° C. or higher. Water may be added as necessary during boiling of the noodles, but it is preferable to adjust the temperature by the fire in view of the temperature decrease and the broth concentration.

By cooking by such a method, it is possible to provide a method for cooking instant broth noodles food with a simmered bone taste, the cooking method being capable of achieving a taste similar to the broth noodles prepared with the simmered bone broth obtained by the simmering method.

Hereinafter, the composition for preparing boiling hot water for broth according to the present embodiment, the instant broth noodles food with a simmered bone taste, and the method for cooking the instant broth noodles with a simmered bone taste will be described in more detail.

### 1. Production of Composition for Preparing Boiling Hot Water for Broth

First, the composition for preparing boiling hot water for broth preparation according to the present embodiment was produced. A composition for preparing boiling hot water for broth enclosed in instant rod-shaped ramen with a pork bone flavor, which is an instant broth noodles food with a simmered bone taste, was produced. The instant rod-shaped ramen with a pork bone flavor undergoes the following steps as a standard cooking process.
(1) Add 400 ml (400 g) of water per person to a pot.
(2) When the pot is heated and the hot water is boiled, the boiling hot water for broth is prepared by adding the composition for preparing boiling hot water for broth for the number of people.
(3) Add noodles for the number of people in the boiling hot water for broth, and boil for 2 minutes and 30 seconds.
(4) Add a seasoning agent corresponding to the number of people to the boiling hot water for broth to prepare a broth with a simmered bone taste.

Here, 8 g of the composition for preparing boiling hot water for broth was added to 400 ml of boiling hot water, and two types of compositions for preparing boiling hot water for broth for adjusting the concentration of the composition for preparing boiling hot water for broth to about 1.96 w/w % in the boiling hot water for broth before boiling of noodles were produced in different amounts of oil, an emulsifier (in the present embodiment, an emulsifier having an HLB of about 3 to 16, preferably about 3 to 13, and more preferably about 7 to 9), and thickening polysaccharide (xanthan gum:guar gum =1:1 to 3 in the present embodiment).

First, for the first type, 5.968 parts by weight of an edible rapeseed oil and 1.600 parts by weight of a flavor oil (rapeseed oil flavored with a flavor material such as garlic) as oil, 0.384 parts by weight of an emulsifier, and 0.048 parts by weight of thickening polysaccharide were weighed.

Next, the edible rapeseed oil was heated to 68 to 75° C., an emulsifier and a thickening polysaccharide were added to disperse the mixture evenly, a flavor oil was further added thereto, and the mixture was cooled to 30 to 40° C. with stirring.

Then, each 8 g (one serving) of the prepared oil was filled in a small plastic film bag to produce a composition for preparing boiling hot water for broth to be enclosed in instant ramen with a pork bone flavor. The first type of composition for preparing boiling hot water for broth is hereinafter referred to as a composition for preparing boiling hot water for broth F1.

The second type was produced by the same production process as that of the composition for preparing boiling hot water for broth F1, but a composition for preparing boiling hot water for broth F2 enclosed in instant ramen with pork bone flavor was produced using 6.288 parts by weight of an edible rapeseed oil and 1.600 parts by weight of a flavor oil (rapeseed oil flavored with a flavor material such as garlic) as oil, 0.04 parts by weight of an emulsifier, and 0.072 parts by weight of thickening polysaccharide.

### 2. Production of Instant Broth Noodles Food With a Simmered Bone Taste

Next, instant rod-shaped ramen with a pork bone flavor was produced as the instant broth noodles food with a simmered bone taste. The composition for preparing boiling hot water for broth (the composition for preparing boiling hot water for broth F1 or the composition for preparing boiling hot water for broth F2) for two persons produced in [1. Production of composition for preparing boiling hot water for broth] described above, rod-shaped noodles for two persons in which one serving is bundled, and a seasoning agent for two persons (filled in individual small bags for one person) in which a pork bone flavor is reproduced without using a raw material derived from a pork such as a pork bone are accommodated in a box-shaped package, thereby producing instant rod-shaped ramen with a pork bone flavor, capable of cooking ramen with pork bone flavor for two persons.

Note that the taste of the above-described seasoning agent is not limited as long as it is a seasoning agent that reproduces the pork bone flavor without using a raw material derived from a pork such as a pork bone just as the taste of the pork bone broth ramen provided at a ramen shop in town is different for each shop.

However, for reference, the seasoning agent produced in this section is a (unused) seasoning agent that does not use animal raw materials, and can be a seasoning agent containing 6.72 to 4.48 parts by weight of a vegetable oil, 4.32 to 2.88 parts by weight of protein hydrolysate, 4.08 to 2.72 parts by weight of sugar, 3.696 to 2.464 parts by weight of soy milk, 3.648 to 2.432 parts by weight of salt, 2.736 to 1.824 parts by weight of a soy sauce, 2.544 to 1.696 parts by weight of sesame, 2.16 to 1.44 parts by weight of yeast extract, 1.68 to 1.12 parts by weight of flavor edible oil, and 2.6016 to 1.7344 parts by weight of seasoning material including at least a garlic, a soybean, an onion, sea tangle, vegetables, a shiitake mushroom, pepper, and ginger. By adding such a seasoning agent to 250 to 350 parts by weight of boiling hot water after boiling of noodles, it is possible to reproduce a pork bone flavor without using a raw material derived from a pork such as a pork bone.

The mixture was a reddish brown liquid, and 40 g per one person was filled into one aluminum pouch to prepare a seasoning agent. The seasoning agent is used for one person (one packet, 40 g) with respect to boiling hot water for one person (about 250 to 350 g) after boiling of the noodles.

### 3. Cooking of Instant Broth Noodles Food With a Simmered Bone Taste

Next, the instant rod-shaped ramen with a pork bone flavor produced in [2. Production of instant broth noodles food with a simmered bone taste] was cooked to prepare ramen with a pork bone flavor for two persons.

First, 800 ml (800 g) of water was put in a pot and boiled, and 2 bags (16 g) of the composition for preparing boiling hot water for broth were added to the boiling water to prepare a boiling hot water for broth.

Next, two bunches of rod-shaped ramen were put into boiling hot water for broth, and subsequently boiling of noodles was performed for 2 minutes and 30 seconds with boiling. The weight of the rod-shaped ramen for one person before boiling of the noodles was 75 g, whereas the weight of the boiled noodles separately measured after draining the hot water after boiling of the noodles was 210 g, and the water absorption associated with boiling of the noodles per one person of the rod-shaped ramen was 135 g.

Next, the heat of the pot was turned off, and the seasoning agent for two persons was added to the boiling hot water for broth in which the boiled noodles were floating and sufficiently dissolved to prepare a broth with a pork bone flavor, thereby preparing ramen with a pork bone flavor for two persons. Each of the prepared instant noodles with a pork bone flavor was placed on a plate, and subjected to appropriate topping for eating.

### 4. Comparative Test 1

Next, a comparison was made on the sensory difference of instant broth noodles with a simmered bone taste depending on the presence or absence of the composition for preparing boiling hot water for broth according to the present embodiment.

Specifically, following the cooking method [3. Cooking of instant broth noodles food with a simmered bone taste] described above (hereinafter, it is also referred to as a standard cooking method), prepared were: the ramen with pork bone flavor A1 using the composition for preparing boiling hot water for broth F1 according to the present embodiment; the ramen with pork bone flavor A2 using the composition for preparing boiling hot water for broth F2 according to the present embodiment; the ramen with pork bone flavor X1 obtained by adding extra 8 g/person of hot water instead of the composition for preparing boiling hot water for broth; and the ramen with pork bone flavor X2 obtained by adding 5.968 g/person of an edible rapeseed oil and 1.600 g/person of a flavor oil instead of the composition for preparing boiling hot water for broth, and compared with the pork bone broth ramen Y prepared using pork bone broth obtained by the simmering method.

Furthermore, the comparison was made by five panelists who have been engaged in the development of a stock or a soup broth for food for many years, by selecting one of the ramen noodles with eating quality most similar to that of the pork bone broth ramen Y from among the ramen with a pork bone flavor A1, A2, X1, and X2. In the comparison, emphasis was placed on the food feeling, feeling of touch on the tongue, body feeling, and depth of richness rather than the aroma and taste of the pork bone broth ramen itself. Each of the five panelists is trained so that the degree of evaluation is approximately the same in a preliminary sensory test performed prior to the sensory test.

As a result, all the panelists selected the ramen with a pork bone flavor A1 or A2 using the composition for preparing boiling hot water for broth according to the present embodiment, the number of panelists who selected the ramen with a pork bone flavor A1 was two, the number of panelists who selected the ramen with a pork bone flavor A2 was three, and according to the panelists, there was only a slight difference in selecting either Ramen A1 or A2 as the first rank. From this, it was confirmed that the ramen with a pork bone flavor A1 and A2 using the composition for preparing boiling hot water for broth according to the present embodiment had eating quality similar to that of the pork bone broth ramen Y prepared with the simmered bone broth obtained by the simmering method, as compared with the ramen with a pork bone flavor X1 and X2 using no the composition for preparing boiling hot water for broth.

### 5. Comparative Test 2

Next, the change in eating quality when the constituent ratios of oil, an emulsifier, and thickening polysaccharide constituting the composition for preparing boiling hot water for broth were changed was examined.

Specifically, the following six compositions for preparing boiling hot water for broth: Po1, Po2, Pe1, Pe2, Pt1, and Pt2 were prepared.

### Composition for Preparing Boiling Hot Water for Broth Po1

As an example in which the concentration of the oil in the boiling hot water for broth is low, a composition for preparing boiling hot water for broth Po1 in which the concentration of the oil in the boiling hot water for broth is 0.390 w/w % by using oil:emulsifier:thickener=1.560:1.600:3.200 and using 6.360 g (concentration 1.565 w/w %) with respect to 400 ml of hot water for one person

### Composition for Preparing Boiling Hot Water for Broth Po2

As an example in which the concentration of the oil in the boiling hot water for broth is high, a composition for preparing boiling hot water for broth Po2 in which the concentration of the oil in the boiling hot water for broth is 5.000 w/w % by using oil:emulsifier:thickener=20.000:0.004:0.004 and using 20.008 g (concentration 4.764 w/w %) with respect to 400 ml of hot water for one person

### Composition for Preparing Boiling Hot Water for Broth Pe1

As an example in which the concentration of the emulsifier in the boiling hot water for broth is low, composition for preparing boiling hot water for broth Pe1 in which the concentration of the emulsifier in the boiling hot water for broth is 0.001 w/w % by using oil:emulsifier:thickener=20.000:0.004:3.200 and using 23.204 g (concentration 5.483 w/w %) with respect to 400 ml of hot water for one person

### Composition for Preparing Boiling Hot Water for Broth Pe2

As an example in which the concentration of the emulsifier in the boiling hot water for broth is high, composition for preparing boiling hot water for broth Pe2 in which the concentration of the emulsifier in the boiling hot water for broth is 0.400 w/w % by using oil:emulsifier:thickener=1.560:1.600:0.004 and using 3.164 g (concentration 0.785 w/w %) with respect to 400 ml of hot water for one person

### Composition for Preparing Boiling Hot Water for Broth Pt1

As an example in which the concentration of the thickener in the boiling hot water for broth is low, a composition for preparing boiling hot water for broth Pt1 in which the concentration of the oil in the boiling hot water for broth is 0.001 w/w % by using oil:emulsifier:thickener=20.000:1.600:0.004 and using 21.604 g (concentration 5.124 w/w %) with respect to 400 ml of hot water for one person

### Composition for Preparing Boiling Hot Water for Broth Pt2

As an example in which the concentration of the thickener in the boiling hot water for broth is high, a composition for preparing boiling hot water for broth Pt2 in which the concentration of the oil in the boiling hot water for broth is 0.800 w/w % by using oil:emulsifier:thickener=1.560:0.004:3.200 and using 4.764 g (concentration 1.177 w/w %) with respect to 400 ml of hot water for one person

In order to compare the six compositions for preparing boiling hot water for broth Po1, Po2, Pe1, Pe2, Pt1, and Pt2, six comparative compositions Po3, Po4, Pe3, Pe4, Pt3, and Pt4 in which the constituent ratios of oil, an emulsifier, and thickening polysaccharide were further greatly changed were prepared.

### Comparative Composition Po3

As an example in which the concentration of the oil in the boiling hot water for broth is low, a comparative composition Po3 in which the concentration of the oil in the boiling hot water for broth is 0.243 w/w % by using oil:emulsifier:thickener=1.560:1.600:3.200 and using 4.000 g (concentration 0.990 w/w %) with respect to 400 ml of hot water for one person

### Comparative Composition Po4

As an example in which the concentration of the oil in the boiling hot water for broth is high, a comparative composition Po4 in which the concentration of the oil in the boiling hot water for broth is 6.101 w/w % by using oil:emulsifier:thickener=20.000:0.004:0.004 and using 26.000 g (concentration 6.103 w/w %) with respect to 400 ml of hot water for one person

### Comparative Composition Pe3

As an example in which the concentration of the emulsifier in the boiling hot water for broth is low, comparative composition Pe3 in which the concentration of the emulsifier in the boiling hot water for broth is 0.0004 w/w % by using oil:emulsifier:thickener=20.000:0.004:3.200 and using 10.000 g (concentration 2.439 w/w %) with respect to 400 ml of hot water for one person

### Comparative Composition Pe4

As an example in which the concentration of the emulsifier in the boiling hot water for broth is further high, comparative composition Pe4 in which the concentration of the emulsifier in the boiling hot water for broth is 0.624 w/w % by using oil:emulsifier:thickener=1.560:1.600:0.004 and using 5.000 g (concentration 1.235 w/w %) with respect to 400 ml of hot water for one person

### Comparative Composition Pt3

As an example in which the concentration of the thickener in the boiling hot water for broth is further low, comparative composition Pt3 in which the concentration of the emulsifier in the boiling hot water for broth is 0.0005 w/w % by using oil:emulsifier:thickener=20.000:1.600:0.004 and using 10.000 g (concentration 2.439 w/w %) with respect to 400 ml of hot water for one person

### Comparative Composition Pt4

As an example in which the concentration of the thickener in the boiling hot water for broth is further high, comparative composition Pt4 in which the concentration of the emulsifier in the boiling hot water for broth is 1.638 w/w % by using oil:emulsifier:thickener=1.560:0.004:3.200 and using 10.000 g (concentration 2.439 w/w %) with respect to 400 ml of hot water for one person

In this Comparative Test 2, using the six compositions for preparing boiling hot water for broth Po1, Po2, Pe1, Pe2, Pt1, and Pt2 and the six compositions for comparison Po3, Po4, Pe3, Pe4, Pt3, and Pt4, the following six types of ramen with a pork bone flavor A1 to A6 and six types of comparative ramen with a pork bone flavor Z1 to Z6 were prepared while following the cooking method [3. Cooking of instant broth noodles food with a simmered bone taste] described above (standard cooking method), and compared with the pork bone broth ramen Y prepared with the pork bone broth obtained by the simmering method.

TABLE 1

| | | Use | Final | |
|---|---|---|---|---|
| | | amount | concentration | |
| | | (g) for | of | |
| | | 400 ml of | composition | |
| | | hot water | in boiling | |
| Prepared | Compositions | for one | hot water for | |
| ramen | used | person | broth | Remarks |
| Ramen with | Composition for | 6.360 | 1.565 w/w % | The final |
| pork bone | preparing boiling | | | concentration |
| flavor A1 | hot water for | | | of oil was |
| | broth Pol | | | 0.390 w/w % |
| Ramen with | Composition for | 20.008 | 4.764 w/w % | The final |
| pork bone | preparing boiling | | | concentration |
| flavor A2 | hot water for | | | of oil was |
| | broth Po2 | | | 5.000 w/w % |
| Ramen with | Composition for | 23.204 | 5.483 w/w % | The final |
| pork bone | preparing boiling | | | concentration |
| flavor A3 | hot water for | | | of an |
| | broth Pel | | | emulsifier is |
| | | | | 0.001 w/w % |
| Ramen with | Composition for | 3.164 | 0.785 w/w % | The final |
| pork bone | preparing boiling | | | concentration |
| flavor A4 | hot water for | | | of an |
| | broth Pe2 | | | emulsifier is |
| | | | | 0.400 w/w % |
| Ramen with | Composition for | 21.604 | 5.124 w/w % | The final |
| pork bone | preparing boiling | | | concentration |
| flavor A5 | hot water for | | | of thickening |
| | broth Pt1 | | | polysaccharide |
| | | | | was 0.001 |
| | | | | w/w % |
| Ramen with | Composition for | 4.764 | 1.177 w/w % | The final |
| pork bone | preparing boiling | | | concentration |
| flavor A6 | hot water for | | | of the |
| | broth Pt2 | | | thickening |
| | | | | polysaccharide |
| | | | | was 0.800 |
| | | | | w/w % |
| Comparative | Comparative | 4.000 | 0.990 w/w % | The final |
| ramen with a | composition Po3 | | | concentration |
| pork bone | | | | of oil was |
| flavor Z1 | | | | 0.243 w/w % |
| Comparative | Comparative | 26.000 | 6.103 w/w % | The final |
| ramen with a | composition Po4 | | | concentration |
| pork bone | | | | of oil was |
| flavor Z2 | | | | 6.101 w/w % |
| Comparative | Comparative | 10.000 | 2.439 w/w % | The final |
| ramen with a | composition Pe3 | | | concentration |
| pork bone | | | | of an |
| flavor Z3 | | | | emulsifier is |
| | | | | 0.0004 w/w % |
| Comparative | Comparative | 5.000 | 1.235 w/w % | The final |
| ramen with a | composition Pe4 | | | concentration |
| pork bone | | | | of an |
| flavor Z4 | | | | emulsifier is |
| | | | | 0.624 w/w % |
| Comparative | Comparative | 10.000 | 2.439 w/w % | The final |
| ramen with a | composition Pt3 | | | concentration |
| pork bone | | | | of the |
| flavor Z5 | | | | thickening |
| | | | | polysaccharide |
| | | | | was 0.0005 |
| | | | | w/w % |
| Comparative | Comparative | 10.000 | 2.439 w/w % | The final |
| ramen with a | composition Pt4 | | | concentration |
| pork bone | | | | of the |
| flavor Z6 | | | | thickening |
| | | | | polysaccharide |
| | | | | was 1.638 |
| | | | | w/w % |

Further, in the comparison, as in [4. Comparative Test 1], five panelists who have been engaged in the development of a stock or a soup broth for food for many years have made a judgment as to whether the noodles are comparable to ramen prepared by a simmering method such as pork bone broth ramen Y based on pork bone broth ramen Y. In the comparison, emphasis was placed on the food feeling, feeling of touch on the tongue, body feeling, and depth of richness rather than the aroma and taste of the pork bone broth ramen itself. Each of the five panelists is trained so that the degree of evaluation is approximately the same in a preliminary sensory test performed prior to the sensory test.

As a result, it was determined that all of the pork bone flavor ramen A1 to A6 were comparable to the ramen prepared by the simmering method.

On the other hand, it was determined that all of the comparative ramen with a pork bone flavor Z1 to Z6 deviated from the range comparable to the ramen prepared by the simmering method.

From these facts, it was shown that the composition for preparing boiling hot water for broth according to the present embodiment is preferably constituted so that 0.390 to 5.000 w/w % of the oil, 0.001 to 0.400 w/w % of the emulsifier, and 0.001 to 0.800 w/w % of the thickening polysaccharide are contained in the prepared boiling hot water for broth before being subjected to noodles boiling in an amount derived from the composition for preparing boiling hot water for broth, the emulsifier, and the thickening polysaccharide.

In addition, it was shown that, when the oil, the emulsifier, and the thickening polysaccharide are blended at a weight ratio of about 0.0002 to 1.1 for the emulsifier and about 0.0002 to 2.1 for the thickening polysaccharide when the oil constituent ratio is 1, a more convenient and suitable boiling hot water for broth can be prepared.

As described above, according to the composition for preparing boiling hot water for broth of the present embodiment, there is provided the composition for preparing boiling hot water for broth according to the present invention is a composition for preparing boiling hot water for broth, in which the boiling hot water for broth is the boiling hot water used to boil the noodles, and after the noodles are boiled, and a seasoning is added to make the broth for broth in an instant broth noodles with a simmered bone taste, in which in the prepared boiling hot water for broth 0.390 to 5.000 w/w % of oil, 0.001 to 0.400 w/w % of an emulsifier, and 0.001 to 0.800 w/w % of a thickening polysaccharide contain the oil, the emulsifier, and the polysaccharide thickener in amounts derived from the composition for preparing the boiling hot water for broth, and therefore when cooking an instant broth noodles food with a simmered bone taste, it is possible to provide a composition for preparing boiling hot water for broth to be used in a cooking method being capable of achieving a taste similar to the broth noodles prepared with the simmered bone broth obtained by the simmering method.

Finally, the above description of each embodiment is an example of the present invention, and the present invention is not limited to the above embodiment. For this reason, it is a matter of course that various modifications can be made according to the design and the like without departing from the technical idea according to the present invention even in a case other than the above-described embodiments.

1. A composition for preparing boiling hot water for broth, wherein the boiling hot water for broth is the boiling hot water used to boil the noodles, and after the noodles are boiled, and a seasoning is added to make the broth for broth in an instant broth noodles with a simmered bone taste, wherein
in the prepared boiling hot water for broth
0.390 to 5.000 w/w % of oil,
0.001 to 0.400 w/w % of an emulsifier, and
0.001 to 0.800 w/w % of a thickening polysaccharide contain
the oil, the emulsifier, and the polysaccharide thickener in amounts derived from the composition for preparing the boiling hot water for broth.

2. The composition for preparing boiling hot water for broth according to claim 1, wherein the emulsifier corresponding to 0.05 to 10 w/w % of the oil is blended.

3. An instant broth noodles food with a simmered bone taste comprising:
the composition for preparing boiling hot water for broth according to claim 1;
noodles; and
a seasoning agent to be added to the used boiling hot water for broth after boiling of the noodles to prepare broth with a simmered bone taste.

4. A method for cooking an instant broth noodles food with a simmered bone taste, comprising:
adding the composition for preparing boiling hot water for broth according to claim 1 to water or hot water to prepare a boiling hot water for broth;
putting noodles into the boiling hot water for broth and boiling the noodles in a state accompanied by boiling; and
adding a seasoning agent for preparing a broth with a simmered bone taste to the boiling hot water for broth to obtain an instant broth noodles with a simmered bone taste.
